(19) United States
(12) Patent Application Publication
(10) Pub. No.: US 2010/0320220 A1
(43) Pub. Date: Dec. 23, 2010

(54) LID FOR A CONTAINER FOR EDIBLE FLUIDS AND A PROTECTIVE COVER FOR THE LID

(76) Inventors: Douglas Hussey, Crewe (GB); Edward Thomas Paine, Crewe (GB)

Correspondence Address: Jackson Walker LLP, 112 E. Pecan, Suite 2400, San Antonio, TX, 78205, US

(21) Appl. No.: 12/813,984

(22) Filed: Jun. 11, 2010

Related U.S. Application Data
(60) Provisional application No. 61/269,186, filed on Jun. 22, 2009.

(51) Int. Cl. B65D 43/08; B31B 49/00

(52) U.S. Cl. 220/796; 493/84

(57) ABSTRACT

A plastic lid for a drinks container, for example, a coffee cup, is provided. The plastic lid is provided with an ancillary access facility in the form of an opening or a part of the lid easily removable to form an opening. The ancillary access facility allows a person to drink from the container without removal of the lid. After the ancillary access facility has been cleaned or de-contaminated it is protected by the application of a protective cover. The protective cover may have a variety of shapes, for example, it may cover all of the lid or it may cover only a selected part of the lid, for example, only the area of the lid involving the ancillary access facility. The protective cover protects the ancillary access facility from the inadvertent transfer of germs to the drinking area by the person dispensing the drinks as they push the lid down with their hands to seal the lid to the container top. The protective covers are arranged to be easily stripped from the lid by the application of mere finger pressure.

### CROSS-REFERENCED TO RELATED APPLICATIONS

This specification is derived from and takes priority from U.S. Provisional Application Patent No. 61/269,186 filed Jun. 22, 2009 in the name of inventor Douglas Hussey who resides at 140 Sandylands Park, Wistaston, Crewe, Cheshire CW2 8HE, U.K. and inventor Edward Thomas Paine who resides at 3 Coppice Road, Winterley, Sandbach, Cheshire, CW11 4RN, U. K. No other inventors are involved in the making of the invention.

### FEDERALLY SPONSORED RESEARCH OR DEVELOPMENT

Not applicable

### TECHNICAL FIELD

The present invention relates to a lid for a container for edible fluids and to a protective cover for the lid.

### BACKGROUND TO THE INVENTION

At the present time edible fluids are sold in containers, for example, of half a pint capacity, comprised of a main body portion made of liquid proof paper construction and a lid of thin plastics material suitable for containing the edible fluids within the container in a sealed leakproof manner well known in the art. In addition to drinking the contents of the container in the usual manner by the complete removal of the plastics lid there is also provision for drinking the contents through an ancillary access facility arranged as part of the lid. The ancillary access facility may be an opening in the lid or an area of the lid easily removable to form an opening. This allows the contents of the container to be consumed without removal of the lid and also allows children to consume the contents of the container by means of a straw. This is an extremely useful facility since it allows the contents of the container to be consumed whilst doing other things such as walking with less risk of spillage.

In this specification the term edible fluids is meant to include drinks such as tea, coffee, other beverages such as milk shakes, fruit juices and is also intended to include edible fluids such as thin soup or gruel

A problem with this known ancillary access facility is that when the container has been filled and the lid is being pressed down onto the top of the container by the hands of the person dispensing the edible fluids to seal the container the ancillary access facility becomes prone to being handled by the person dispensing the drinks. Accordingly unless personal hygiene is strictly observed there is a risk of harmful bacteria being inadvertently transferred or deposited on the ancillary access facility and surrounding area with possible contamination of this area.

A further consideration is that in a busy coffee shop, for example, there may well be one or more queues of customers waiting to be served and it is important that they be served as quickly and as safely as possible. To this end it is usual to have a stack of cups handily disposed to allow the attendant to quickly fill the cups and also important to have a stack of lids handily disposed for sealing the containers after they have been filled. It is important, therefore, that the design of lid does not compromise stacking in any way. For example it is believed that it is far easier to grasp the top of the lid between thumb and forefinger rather than grasping a radially extending tab because of the difficulty of separating the tabs when closely stacked.

### DISCUSSION OF THE PRIOR ART

U.S. Pat. No. 7,111,749 B1 (Akers) discloses a lid for a coffee cup having a drinking opening and a cover piece to cover the drinking opening. Following the teaching of this patent the user's finger will contact the area of the drinking opening when the protective cover is being applied to the lid. Consequently there is considerable risk that harmful bacteria or germs could be transferred to the drinking opening during the assembly of the cover to the lid. Consequently it cannot be said that the protective cover has been applied to the lid in a hygienic manner.

US patent 2004/0084452 A1 (Wu-Chang Hsieh) discloses a first lid for a sealing a container and a second outer lid covering the first lid. To obtain proper operation in accordance with this patent the outer lid is larger in diameter than the first lid so there can be relative rotation between the lids to align different drinking openings. Consequently the lids cannot be sealed as required by the present invention.

Int Publication WO 96/16871 (Kaneko) discloses a lid thermally fused bonded to the container body and consequently is not pertinent to the present invention which is concerned with solving the problem of inadvertent transfer of germs when the lid is pressed down by the hands of the person dispensing the drinks. It is notable that this patent emphasises the fact that when the lid is made of plastics material dust is particularly apt to deposit on the lid due to static electricity and in the presence of such dust it is unsanitary to directly touch the drinks opening with the mouth.

WO 2006/039044 A3 (Solo Cup Corp) despite comprising some 68 pages of description and some 97 claims there is no awareness in this patent of the problem of inadvertent transfer of germs to the lid by the person dispensing the edible fluids or drinks and consequently no teaching of a de-contamination step in the method of producing the container lids. One of the disclosed embodiments has an elongate cover with a tab member extending radially into free space. During use there is a distinct risk that the lower finger could come into contact with the area of the drinks opening with possible transfer of germs to the drinks opening. In another embodiment a slidable cover element is constrained to move sideways to cover and uncover a drinks opening by means of an upstanding tab member arranged very close to one end of the movable cover. Because of the closeness of the tab to the end of the slidable cover there is distinct risk that the fingers moving the tab member could contact the area of the drinks opening with possible contamination thereof.

United States Patent Publication 2003/0089714 A1 (Dart et al). In this patent there is clearly no awareness of the possibility of the inadvertent transfer of germs to the lid by the hands of the person dispensing the drinks and, thus, no suggestion of a de-contamination step in the lid production process In one embodiment a graspable tab member is formed which when grasped by the fingers and thumb could result in finger contact being made with the area of the drinks opening. In another embodiment when the tab member carrying the downwardly extending closure plug is hinged backwardly the closure plug is exposed to atmospheric dust with the then propensity for collecting such dust which ultimately will be transferred to the drinks opening.

JP patent 10236494 discloses a lid being pressed down onto a container body by pressing equipment for permanent attachment thereto hence this disclosure is not pertinent to the problem of inadvertent transfer of germs by the hands of the person dispensing the drinks. A section of the lid includes through perforations allowing seepage of the contents which can only be contained by the addition of a separate cover. The possibility of the contents swilling around between the lid and the cover presents a most unhygienic arrangement.

U.S. Pat. No. 5,692,616 (Baker) discloses enveloping a lid within upper and lower plastic sheets (cellophane) with the lower sheet ultimately being withdrawn through the drinks opening. With the propensity of plastic sheets to attract atmospheric dust this is clearly not a hygienic arrangement.

An object of this invention is to alleviate, at least, to some extent these problems present in the prior art.

### SUMMARY OF THE INVENTION

According to one aspect of the present invention there is provided a method of manufacturing a lid for a container for edible fluids, the method including the step of providing an ancillary access facility on the lid, the method including the further steps of de-contaminating the ancillary access facility and protecting the de-contaminated ancillary access facility from future contamination.

According to a second aspect of the invention there is provided a lid for a container for edible fluids, the lid having an outer peripheral rim and being arranged to seal edible fluids within the container due to frictional engagement of the rim when pressed down onto the container by the person dispensing the edible fluids, the container lid including an ancillary access facility allowing access to the contents of the container without removal of the lid and a protective cover applied to the lid in a hygienic manner to seal and protect the ancillary access facility from the transfer of harmful bacteria during the process of the lid being pressed down onto the container by the hands of the person dispensing the edible fluids wherein the unsealing of the protective cover to allow consumption of the contents of the container frees the protective cover from the lid and allows free movement of the protective cover for disposal thereof.

Consumers are not privy to the private actions of the dispensing attendants so when they see their lid being pressed down on to the container they might well be asking “Where have those hands been”? “Have they been cleaned”? Are they clean now”? “What germs could I be imbibing with my drink”? An advantage of the invention is that the sight of the protective cover of the invention reassures the consumer that the drinks opening has been de-contaminated and thereafter protected so no risk of infection exists. To facilitate this the protective cover can be made a distinctive cover in contrast to the basic lid cover. For example the colour green would provide the protective cover with connotations of safety.

### BRIEF DESCRIPTION OF THE DRAWINGS

The invention will now be described with reference to the undernoted drawings wherein:

FIG. 1 illustrates a container body for edible fluids and a container lid in accordance with the invention for the container body.

FIG. 2 illustrates a part cross-sectional view of a first embodiment of a lid and protective cover in accordance with the invention.

FIG. 3 illustrates a part plan view of the lid of FIG. 1.

FIG. 4 illustrates a part plan view of a second embodiment of a lid and cover in accordance with the invention.

FIG. 5 illustrates a part cross-sectional view of a third embodiment of a lid and protective cover in accordance with the invention.

FIG. 6 illustrates a part cross-sectional view of a third embodiment of a lid and protective cover in accordance with the invention.

FIGS. 7 & 8 illustrate part cross-sectional views of a lid and protective cover in accordance with a fourth embodiment of the invention.

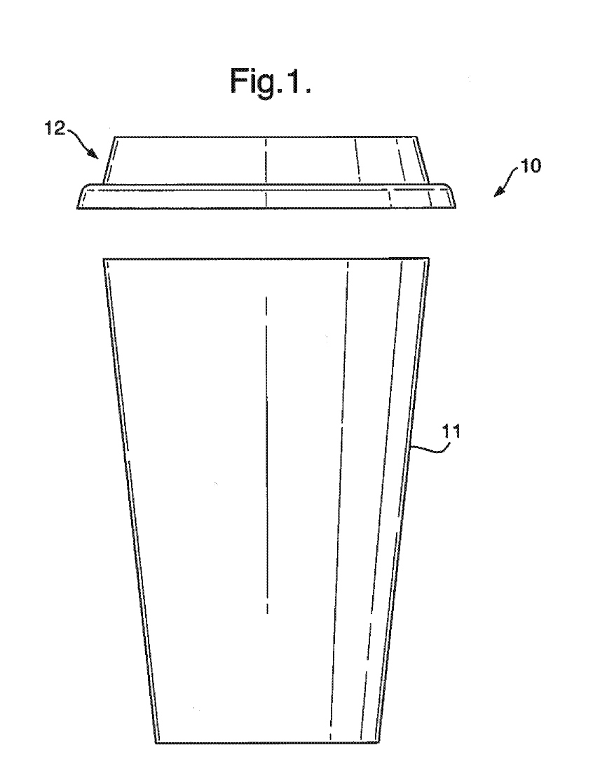

In FIG. 1 reference numeral 10 denotes a container for edible fluids comprising a tapered container body 11 and a co-operating lid 12 in accordance with the invention.

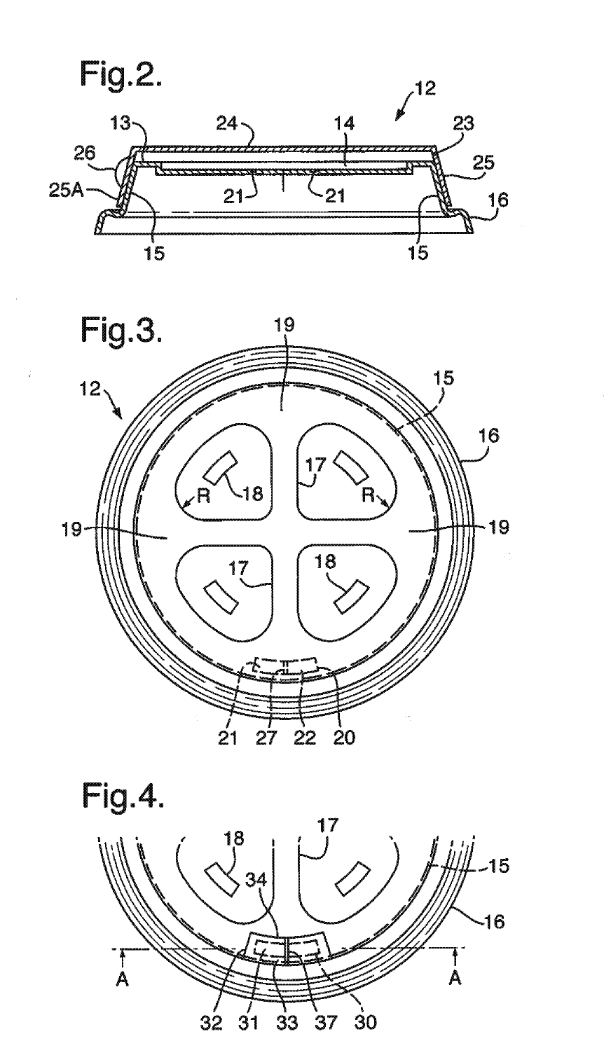

As best seen in FIG. 2 circular lid 12 includes a top portion 13 with a pressed out depressed area 14 which strengthens the lid structure. From top portion 13 a depending side wall 5 angles or tapers outwardly and downwardly to join outwardly and downwardly extending outer peripheral rim 16 which is dimensioned to be a friction fit to seal around the circular top of the container body portion 11 for easy removal and disposal after use.

As best seen from FIG. 3 raised ribs 17 strengthen the lid 12. Pressed out areas 18 may be used to identify different types of edible fluids such as coffee, tea or other drinks. The areas 19 adjoining ribs 17 are maximised by increasing the relevant radii R to encourage the pressing down on these areas by the attendant dispensing the edible fluids, or drinks, to seal the container after filling.

In accordance with this first embodiment of the invention an ancillary access facility is delineated by the outline 20, see FIG. 3 and comprises a series of semi-circular shallow indentations or concavities 21 best seen in FIG. 2. The weakening of the lid structure in this way ensures that the area delineated by outline 20 is able to seal the container but may be easily ruptured under finger pressure to provide an opening 22 which will allow a person to drink the contents of the container via opening 22 or insert a straw therein without removal of the lid 12. Alternatively an opening 22A may be conveniently formed on top of one of the stepped areas between walls 14A of depressed area 14 (see FIG. 6) and sidewall 15.

An important part of this first embodiment of the invention comprises a protective cover in the form of a hygienic cap or barrier 23 best seen in FIG. 2 which is applied to seal or protect the ancillary access facility 20 arranged on the lid 12. Since the cap or barrier 23 and lid 12, for that matter, are throwaway items, that is, they will be disposed off after use, it is important for volume production and reduced costs that they are of plain construction, that is, they do not involve relatively slidable, hingeable or other moving parts. Hygienic cap 23 has a flat circular top part 24 and from FIG. 2 is seen to have a generally inverted U-shaped cross-sectional structure matching the tapering sidewall of lid 12. In this case a depending sidewall 25 of cover 23 matches the taper of sidewall 15 of lid 12 but other structural shapes could be chosen. It will be noted that cap 23 and tab 26 do not extend beyond the periphery of outer rim 16. It is believed this is advantageous in that stacking will not be compromised.

Once the lid or only the ancillary access facility and surrounding area and the protective cap have been cleaned or de-contaminated, for example, by being contacted by disinfecting material such as by spraying or dipping in such a solution or subjected to another treatment such as exposure to ultraviolet light the assembly thereto of hygienic cap 23 ensures that the de-contaminated lid cannot be touched by a person dispensing the edible fluids or drinks but may only be accessed by the person preparing to drink through opening 22. Hygienic cap 23 may be sealingly attached to lid 12 by means of a friction fit around sidewall 15 or attached by other means, for example, a lightly applied suitable weak inert adhesive so that it can be easily twisted off and removed for disposal. Hygienic cap 23 may be attached to the lid in a hygienic manner by ensuring the handling of cap 23 is confined to the outer surface 25A of cap 23. Thus any contact with the de-contaminated ancillary access facility on top of the lid is prevented.

Hygienic cap 23 may be made of thin opaque or transparent plastics material similar in thickness (0.008-0.020 ins), possibly thinner, to the prior art lid mentioned above but which, nevertheless, has sufficient rigidity such that when fitted to lid 12 the combined lid and cap assembly will be able to be stacked with other assembled lids and caps. Tab members 26 may be added to facilitate removal of cap 23 but it is important they do not compromise stacking of the lid. For example, they should conform to the shape of the lid and not extend radially into free space which could compromise the stacking of the lid. They could be made to be flexible so that they could lie flat unobtrusively along the top surface of the lid. Similarly a tab member 37 may be added to ancillary access facility as shown in FIG. 4.

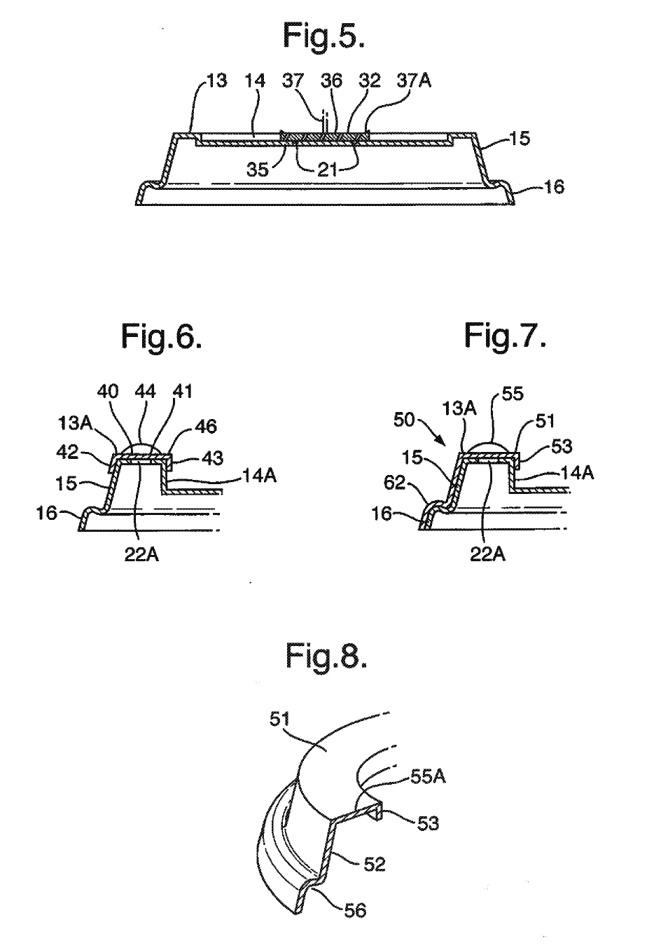

A second embodiment of the invention is illustrated in FIG. 4. Instead of providing a hygienic cap or barrier 23 covering all of the area of the top surface of the lid, FIG. 4 illustrates how a localised area only around the drinks opening may be protected and still meet the object of the invention. In this embodiment an ancillary access facility is in the form of an outline area 30 weakened by indentations 21, see FIG. 5 which is a section on A-A of FIG. 4 and which may easily be ruptured under light finger pressure and if so ruptured and removed will result in an opening 31 being formed in the lid structure. In this second embodiment of the invention the area delineated by reference numeral 30 and surrounding area is covered or protected by hygienic mouthpiece cover 32. Cover 32 may be made of pliable plastics material or solid mouldable material which, nevertheless, is not meant to exclude foam material capable of maintaining a stable shape and approximates to an area covered by the lips when a person is drinking through opening 31. It is desirable that cover 31 be as small as possible compatible with covering the drinks opening and surrounding area so that unnecessary wastage is avoided when it is disposed off after use. Hygienic protective mouthpiece cover 32 prevents this area from being handled by the person dispensing the drinks and thereby prevents the inadvertent transfer of germs to this area by the person dispensing the drinks.

The mouthpiece cover 32 is sealingly maintained in position over outline 30 and surrounding area by a suitably weak inert adhesive which is strong enough to retain cover 32 in position but may easily be removed under finger pressure and when so removed there will be sufficient adhesion between cover 32 and the weakened outline area 30 such that area 30 will be removed with cover 32 and an opening 31 will be formed in the lid structure. A person may then drink through this opening or insert a straw therein.

It is important that the protective cover 32 be applied to the de-contaminated area in a hygienic manner. This may be done with reference to FIG. 4 wherein protective cover 32 has a front side edge 33 and a rear side edge 34 which are curved to conform to the circular periphery of the lid top 12. A flat bottom surface 35, see FIG. 5, is treated with suitable adhesive whilst a flat top surface 36 carries a centrally disposed pull tab 37. Pull tab 37 may extend substantially at right angles to top surface 36 but not extend so far as to compromise stacking. Alternatively pull tab 37 may be made of flexible material so that it may lie unobtrusively on top part 36 or may simply have raised end portions 37A. Accordingly as can be seen from FIG. 4, cover 32 has been hygienically applied to the ancillary access facility, that is, opening 31, since pull tab 37 can be grasped between finger and thumb whilst the top surface 36 prevents the finger and thumb from contacting drinks opening 31 during application to or removal of cover 32 from lid 12.

FIG. 6 illustrates a third example or embodiment of the invention wherein an opening 22A is formed on lid top 13A. A protective hygienic mouthpiece cover 40 comprises a main flat body portion 41 having side portions 42,43 extending from the main body portion 41 and conforming to the tapering sidewalls 25 and 14A of the lid 12. As can be seen from FIG. 6 this results in a generally inverted U-shaped tapering cross-sectional structure similar to the cross-sectional structure of cap 23 illustrated in FIG. 2. A centrally disposed pull tab 44 may be added to the top surface 45 of main body portion 41. This may be grasped between finger and thumb for removal of cover 40 for ultimate disposal but also together with top surface 45 it prevents the finger and thumb from contacting the drinks opening 22A. Instead of a proper pull tab the top surface 45 may have slightly raised end portions 44A as described with reference to FIG. 5 to assist in manipulating cover 40 to uncover opening 22A.

In this embodiment cover 40 may be arranged to be a friction fit relative to lid 12 on the stepped portion thereof to seal opening 22A and pull tab 44 or raised portions 44A may be used to slide cover 40 sideways along the stepped wall portion to uncover opening 22A for interim use, that is, a person may not wish to consume all of the contents of the container at one sitting, prior to disposal. In the absence of tab 44 it should be noted the combination of sidewall member 42 with flat body portion 41 will prevent the fingers contacting opening 22A.

FIG. 7 illustrates a fourth embodiment of the invention wherein a hygienic cover 50 comprises a main flat body portion 51 covering opening 22A and having side extension members 52, 53 conforming to the tapering sidewall structure of lid 12 and from FIG. 7 is seen to exhibit a generally inverted U-shaped tapering cross-sectional structure described above with reference to FIGS. 2 and 6. In this fourth embodiment, however, sidewall portion 52 is extended to follow the tapering or angled contour of lid sidewall 15 to the outer peripheral rim 16. Thus the friction fit between cover 50 and lid 12 is extended over that shown in FIG. 6.

For interim use cover 50 may be slid to one side on stepped wall 13A using pull tab 55 or raised portion 55 A to expose opening 22A. If desired the friction fit may be supplemented by the use of weak inert adhesive but, of course, this would prevent interim use.

The slight upward taper of stepped wall portions 15 and 14A will provide some initial impetus for upward movement to remove cover 50 for disposal by pinching between finger and thumb whilst at the same time preventing finger and thumb from contacting the drinks opening 22A. The length of each localised cover 40, 50 will be such as to provide an area approximating to a person's mouth when drinking through the opening 22A and preferably is shaped somewhat similar to the quadrant of a circle.

As seen in the perspective view of FIG. 8 protective cover 50 has a front side extending member 52 tapering or angling outwardly and downwardly from top portion 51 to an outer peripheral rim portion 56 which corresponds with outer peripheral rim 16 of lid 12 and is arranged to be a friction fit thereto and of similar thickness. A rear extending angled or tapered member 53 also depends from top portion 51 and together with angled or tapered sidewall extending member 52 enables the cover 50 to be friction fitted to the lid stepped wall portion formed by walls 14A and 15 of the lid 12 which contains the drinks opening 22A. This version of the invention may be more conducive to stacking than any of the examples using pull tabs.

Whilst the transparency of hygienic cap 23 is useful because it allows information on top of the lid to be read, protective covers 32, 40 and 50 are preferably made a distinctive colour so that they may be easily distinguished from the parent lid and thus reassure consumers that the drinks opening has been de-contaminated and suitably protected from inadvertent transfer of harmful bacteria. The colour green for the protective cover could convey connotations of safety or reassurance to the consumer. Ultraviolet light is only one example of medium wave electromagnetic radiation suitable for de-contaminating the lid and ancillary access facility. Alternatives for the de-contaminating step include pre-treatment with disinfecting gases such as Oxygen or Argon. Thus it can be seen that various means for protecting the lid and the ancillary access facility have been provided in accordance with the invention.

1. A method of manufacturing a lid for a container for edible fluids, the method comprising
the steps of:
providing an ancillary access facility on the lid;
de-contaminating the ancillary access facility; and
protecting the ancillary access facility from future contamination.

2. A method of manufacturing a lid for a container for edible fluids according to claim 1, the lid having an outer peripheral rim and, in use, being arranged to seal edible fluids within the container due to frictional engagement of the rim when pressed onto the top of the container by the hands of the person dispensing the edible fluids, the method including the further step of:
applying a protective cover to seal the ancillary access facility after the ancillary access facility has been de-contaminated.

3. A method of manufacturing a lid for a container for edible fluids according to claim 2 wherein:
the protective cover is subjected to a de-contamination step prior to being applied to the lid.

4. A method of manufacturing a lid for a container for edible fluids according to claim 2 wherein:
the protective cover is applied over the whole of the top of the lid.

5. A method of manufacturing a lid for a container for edible fluids according to claim 2 wherein:
the protective cover is applied only to the ancillary access facility and the localised area surrounding the ancillary access facility.

6. A method of manufacturing a lid for a container for edible fluids according to claim 2 wherein:
the protective cover is sealed to the lid by means of an inert adhesive.

7. A method of manufacturing a lid for a container for edible fluids according to claim 1 wherein:
the protective cover is sealed to the lid by means of a friction fit

7. A method of manufacturing a lid for a container for edible fluids according to claim 1 wherein:
the de-contamination step comprises contacting the ancillary access facility with disinfecting material.

8. A method of manufacturing a lid for a container for edible fluids according to claim 1 wherein:
the de-contamination step involves subjecting the ancillary access facility to ultra violet light.

10. A method of manufacturing a lid for a container for edible fluids according to claim 1 wherein the ancillary access facility is a sealed but easily removable part of the lid under finger pressure.

11. A method of manufacturing a lid for a container for edible fluids according to claim 1 wherein:
the protective cover is applied to the lid in a hygienic manner insofar as the fingers of the person applying the protective cover are prevented from contacting the opening.

12. A method of manufacturing a lid for a container for edible fluids according to claim 2 wherein:
the protective cover has a generally inverted U-shaped cross-sectional structure.

13. A method of manufacturing a lid for a container for edible fluids according to claim 1 wherein:
a part of the protective cover conforms to the shape of the lid.

14. A lid for a container for edible fluids, the lid having an outer peripheral rim and being arranged to seal edible fluids within the container due to frictional engagement of the rim when pressed onto the container by the person dispensing the edible fluids, the container lid including an ancillary access facility allowing access to the contents of the container without removal of the lid and a protective cover applied to the lid in a hygienic manner to seal and protect the ancillary access facility from the transfer of harmful bacteria during the process of the lid being pressed onto the container by the hands of the person dispensing the edible fluids wherein the unsealing of the protective cover to allow consumption of the contents of the container frees the protective cover from the lid and allows free movement of the protective cover for disposal thereof.

15. A lid for a container for edible fluids according to claim 14 wherein the lid includes a stepped wall portion and the ancillary access facility is an opening formed on the stepped wall portion, the protective cover including side wall portions fitted to the stepped wall portion wherein one of the side wall portions extends to the rim and is a friction fit therewith.

16. A lid for a container according to claim 15 wherein the sidewall portions are free of any protuberances preventing upward movement thereof.

17. A lid for a container for edible fluids according to claim 14 including an upstanding tab member situated substantially centrally of the protective cover.

18. A lid for a container according to claim 14 wherein the protective cover has a U-shaped cross-section.

19. A lid for a container for edible fluids according to claim 14 wherein the protective cover conforms to the shape of the lid and no part extends radially into free space.

20. A lid for a container for edible fluids according to claim 14 wherein the lid and the protective cover are of distinctive colours relative to each other.
